(19) United States
(12) Patent Application Publication
(10) Pub. No.: US 2007/0258411 A1
(43) Pub. Date: Nov. 8, 2007

(54) Adaptive null streering for frequency hopping networks

(75) Inventor: Hafedh Trigui, Ottawa (CA)

Correspondence Address: Lawrence G. Kurland, Esq.;BRYAN CAVE LLP, 1290 Avenue of the Americas, New York, NY, 10104-3300, US

(73) Assignee: TenXc Wireless Inc.

(21) Appl. No.: 11/784,384

(22) Filed: Apr. 5, 2007

(30) Foreign Application Priority Data
Apr. 7, 2006 (CA) 2,542,410

(51) Int. Cl. H04B 7/216

(52) U.S. Cl. 370/335

(57) ABSTRACT

A method and apparatus for performing adaptive null steering in a slow frequency hopping environment. Where base stations have smart beamforming antenna capability and are interconnected by a base station controller, thus accommodating cyclic and pseudo-random frequency hopping, each base station forwards information on arrival time, frequency and received power of all subscriber communications and co-channel interferers to the controller for correlation. Periodicity information relating to co-channel interferers is returned to the applicable base station, to enable the generation of a null in the direction of arrival of the interferer. Where few base stations have smart beamforming capability, frequency hopping is cyclic only, and each base station generates its own periodicity information. Base stations may also calculate direction of arrival and time of arrival information, and forward this to the controller, if applicable. The invention enhances network capabilities including a subscriber localizing capability hitherto unavailable to network operators.

### CROSS REFERENCE TO RELATED APPLICATIONS

This application claims the benefit of Canadian Patent Application Serial No. 2,542,410, filed Apr. 7, 2006, which disclosure is incorporated herein by reference in its entirety.

### FIELD OF THE INVENTION

The present invention relates to wireless networks and in particular to a method of adaptive null steering in frequency hopping wireless networks for forward and reverse links.

### BACKGROUND TO THE INVENTION

Diversity is a concept of interest in wireless communications systems. Time, frequency, antenna, polarization and space are diversity resources that may typically be used in current and future systems.

Of particular interest are frequency diversity and frequency hopping implementations making use thereof.

When a static channel is allocated to a subscriber, some deep fading caused by destructive addition of multi-path components may occur at some locations and result in significant quality degradation or even dropped calls.

The Global System for Mobile Communications (GSM) standard solved this problem to some extent by rapidly varying the frequency of the channel over either a deterministic pattern or a pseudo-random one. The former system is called cyclic frequency hopping and the latter is called random frequency hopping.

In either case, there is a fixed set of frequencies {f₁, f₂ . . . f_{N}} that could be used by a specific transceiver.

In cyclic frequency hopping, the transceiver uses, as a function of time, a deterministic pattern f₁,f₂ . . . f_{N},f₁, f₂ . . . .

By contrast, in random frequency hopping, both the transmitter and the receiver generate pseudo-random numbers between 1 and N using the same pseudo-random number generation method, for every frame. The transmitter and receiver will be tuned to one of a subset of frequencies corresponding to the generated pseudo-random number.

In either case, while changing the frequency of the transceiver does not avoid fading, it reduces its probability of occurrence and therefore increases the average performance of the system.

Furthermore, frequency hopping tends to enhance channel coding as well. In a network where all of the subscribers are using frequency hopping, co-channel interferers to a specific subscriber will also vary every frame, resulting, at the network level, in an interference averaging effect and therefore even better network performance.

It has been shown that random frequency hopping performs higher than cyclic frequency hopping and is therefore the frequency hopping method of choice among operators.

As conventional wireless systems approach their capacity in the face of burgeoning subscriber demand, interference has become a significant concern. Interference reduction mechanisms that can allow the available spectrum to be shared more efficiently and thus accommodate a greater number of subscribers have proved very popular.

One interesting mechanism is beamforming. It is known that by using an antenna array, the radiation pattern can be tailored to maximize the received signal from a particular direction while canceling co-channel interferers in other directions by placing deep nulls in those directions.

At the network level and for the uplink (reverse) channel, that is, from a mobile user to a base station, beamforming is very effective in rejecting interference. On the other hand, frequency hopping provides the benefit of avoiding deep fading on an ongoing basis.

Happily, beamforming and frequency hopping are complementary systems that are available to the operator. For example, the technique described in Wells, M.C. “Increasing the capacity of GSM cellular radio using adaptive antennas”, IEEE Proceedings on Communications, October, 1996, is an exemplary adaptive null steering method that could be used for the uplink channel. In order to be frequency hopping independent, however, every burst of data is treated independently of others.

Were frequency hopping to be disabled across the entire network in a beamforming system, then the estimated interference information obtained from the uplink channel could conceivably be used to provide some interference cancellation for the downlink (forward) channel, that is, from the base station to the mobile user. The base station would be able to tailor its radiation pattern to focus power on the served subscriber and to create nulls in the directions of the predicted interferers. As a result, any subscriber in the network would see less interference from other base stations in the downlink channel and signal quality degradation due to interference would be removed. Further, with the effective removal of interference in both the uplink and downlink channels, capacity, as well as coverage, would improve.

Unfortunately, however, adaptive null steering on its own would not avoid or compensate for persistent deep fading should it occur in a region or regions of the sector being served. Moreover, wireless operators prefer to continue deploying frequency hopping throughout the network in conjunction with beamforming.

One mechanism to permit downlink beamforming in a frequency hopping environment is to simply direct a narrow beam towards the desired subscriber and to not create nulls directed toward interferers. If the interferers are directionally far apart from the desired subscriber, this may be adequate because side-lobe levels are typically more than 10 dB below those of the central or main beam. However, if the beams are not sufficiently narrow, there is a high likelihood that some subscribers would still suffer from interference from interferers that are not directionally remote. Even so, to generate narrow beams, more antenna columns would be appropriate, which would significantly increase the cost of the system.

One of the benefits of null steering is that similar or better performance of narrow beams could be achieved with fewer antenna columns and therefore a cheaper system.

However, an additional complication of null steering for some standards arises from the fact that typically, downlink communication precedes uplink communication. In such a scenario, on the initial downlink communication, there would be no information about the location of interferers, even in the absence of frequency hopping, so that null steering to reduce interference could not be implemented on this initial communication.

### SUMMARY OF THE INVENTION

Accordingly, the present invention seeks to provide an adaptive null steering method that incorporates frequency hopping.

Furthermore, the present invention seeks to provide a suite of new network capabilities hitherto unavailable to network operators.

According to a first broad aspect of an embodiment of the present invention, there is disclosed a method of adaptive null steering of signals between a first base station and a subscriber in a first cell of a wireless frequency hopping network, and a second base station and at least one interferer in a second cell that periodically communicates along at least one common frequency simultaneously used in communications between the first base station and the subscriber and interferes therewith, comprising the steps of: (a) measuring arrival information and a time received of a subscriber signal emanating from the subscriber and received by the first base station along a first subscriber frequency; (b) measuring arrival information and a time received of an interferer signal emanating from the interferer along a first interferer frequency and received by the first base station; (c) repeating all previous steps, for subsequent frequencies, until a periodicity of simultaneous communication by the interferer along the interferer signal and the subscriber along the subscriber signal can be established with the first base station along one of the at least one common frequency; and (d) thereafter generating, at the first base station, a null in a most recent direction of the interferer signal, when the first base station and the subscriber communicate and the interferer interferes therewith along the at least one common frequency; whereby interference by the interferer with communications between the first base station and the interferer along the at least one common frequency can be attenuated.

According to a second broad aspect of the present invention, there is disclosed a system for adaptive null steering of signals in a wireless frequency hopping network comprising: a first base station having a first cell; a subscriber operatively connected to the first base station and operatively located in the first cell; a second base station having a second cell; and at least one interferer operatively connected to the second base station and operatively located in a second cell; and wherein the interferer is adapted to periodically communicate along at least one common frequency simultaneously used in communications between the first base station and the subscriber, wherein the first base station is adapted to measure the arrival information and a time received of a subscriber signal emanating from the subscriber and received by the first base station along a first subscriber frequency, and adapted to measure the arrival information and a time received of an interfere signal emanating from the interferer along the at least one common frequency and received by the first base station, and wherein the first base station is adapted to repeat the measurements for subsequent subscriber and interferer frequencies, until a periodicity of simultaneous communication by the interferer and between the subscriber and the first base station along the at least one common frequency, can be established by the first base station, and wherein the first base station is adapted to generate a null in a most recent direction of the second signal, when the first base station and the subscriber communicate and the interferer interferes therewith along the at least one common frequency, to attenuate the interference by the interferer signal.

### BRIEF DESCRIPTION OF THE DRAWINGS

The embodiments of the present invention will now be described by reference to the following figure, in which:

FIG. 1 is an illustration of a wireless network system for adaptive null steering of signals according to the present invention.

### DETAILED DESCRIPTION OF THE PREFERRED EMBODIMENTS

The invention will be described for the purposes of illustration only in connection with certain embodiments.

However, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

The present invention includes both a method and a system for adaptive null steering of signals communicating with base stations in a wireless network.

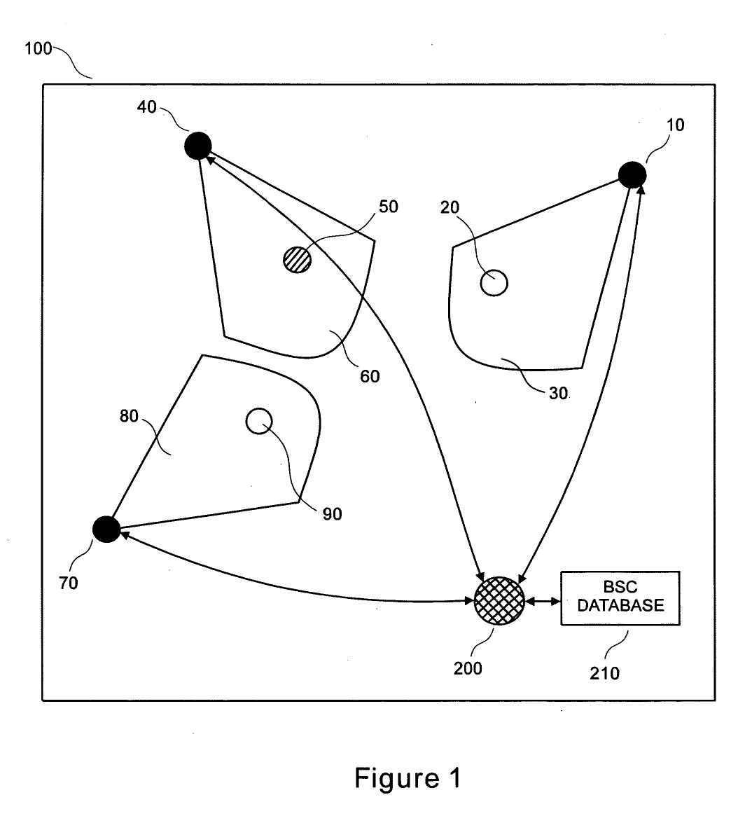

FIG. 1 illustrates a wireless network system, shown generally at 100 that embodies the present invention. The system 100 includes a first base station 10 and a first subscriber 20. Both the first base station and the subscriber are operatively situated in a first cell 30. The system 100 also includes a second base station 40 and at least one subscriber 50, which subscribes to the second base station 40. As the subscriber 50 is subscribed to the second base station 40, to the extent that signals from it reach the first base station 10 or vice versa, the subscriber 50 is treated as an interferer in respect of the first base station 10. Both the second base station and each interferer 50 are operatively situated in a second cell 60.

FIG. 1 also shows a third base station 70 and corresponding third cell 80 as part of the wireless network system. An additional subscriber 90 of the third base station is operatively situated within the third cell and again would be treated as an interferer from the perspective of the first base station 10.

It should be understood that multiple base stations and corresponding cells may be located within the system 100. In addition, each base station has processing means and a database (neither of which are shown). The database stores information relating to the various subscribers in its cell, or interferers from other cells, for processing according to the method of the present invention. Furthermore, multiple interferers, in addition to the interferer 50, shown in FIG. 1, are contemplated as part of the system of the present invention.

The present invention also recognizes that, typically, many of the network base stations are in communication with a central base station controller (BSC) 200, as shown in FIG. 1. The BSC 200 communicates with each of the base stations 10, 40, and 70. The BSC 200 also maintains knowledge of all of the active subscribers in its area of influence and control. According to the exemplary embodiment of FIG. 1, the BSC maintains knowledge of subscribers 20, 50 and 90.

In an alternative embodiment to the present invention, the BSC 200 includes a BSC database 210 that centrally stores information regarding subscribers and their potential interferers. The BSC database 210 is also adapted to predict potential interferers according to the method of the present invention.

According to a first exemplary embodiment, the present invention provides a method whereby base stations communicate estimates of the direction of arrival (DoA) of their active subscribers and potential co-channel interferers to the BSC. The greater exchange of information is correlated and used to predict, based on the periodicity of the cyclic (and even the pseudo-random) frequency hopping systems, which interferers are likely to appear relative to a given active subscriber and the cell in which it appears. With this information, the cell base station is equipped to perform null steering to attenuate the signal response of such interferers on the uplink channel and steer a signal along the downlink channel to a desired subscriber for improved signal quality while reducing the radiated power towards co-channel subscribers.

For example, consider a subscriber A in a given cell a (neither shown). Assume that subscriber A communicates along frequency f₁ in the current time slot (designated frame 0), and frequency f₆ in the next time slot (frame 1) in accordance with its frequency hopping scheme.

Now, assume that subscriber B in cell β (neither shown) communicates along frequency f₁ in frame 0 and frequency f₂ in frame 1, while subscriber C in cell γ (neither shown) communicates along f₁ in frame 0 and frequency f₉ in frame 1.

Thus, in frame 0, subscribers B and C, which both communicate along frequency f₁, may constitute co-channel interferers to subscriber A from the perspective of the base station for cell ∝ during that frame.

As with many prior art null steering antenna systems, base station α (not shown) maintains information on its subscribers and any co-channel interferers therewith, such as, in this case, subscribers B and C. This information includes the DoA of the received signal from A and its co-channel interferers, together with the signals' times of arrival (ToA). In accordance with the present invention, base station α forwards the DoA and ToA information that it gathers in respect of subscribers A, B and C in frame 0, to the BSC (not shown), which identifies subscribers B and C as potential co-channel interferers to subscriber A.

However, neither subscribers B nor C will constitute co-channel interferers in the subsequent frame, because their respective cell's frequency hopping scheme have directed that they communicate along different frequencies than that of subscriber A. On the other hand, there may be other subscribers, say subscriber D in cell δ (not shown), that communicates along frequency f₆ in frame 1. Thus, in frame 1, base station α would not receive any signal from either subscribers B or C that would cause it to generate a DoA or ToA estimate, but it would generate and communicate to the BSC such estimates in respect of subscribers A and D.

As frames progress, base station α continues to forward to the BSC, estimates of DoA and/or ToA in respect of A, and indeed, all active subscribers within cell a, together with those of any co-channel interferers therewith.

By the same token, each of the base stations similarly reports to the BSC on its active subscribers and its co-channel interferers on a frame by frame basis.

Some, and indeed a large amount, of such information will overlap. For example, in frame 0, if subscribers A, B and C all operate on the same frequency, base stations β and γ (neither of which are shown) will be forwarding DoA and/or ToA information to the BSC regarding subscribers B and C respectively, and their co-channel interferers, which may conceivably include subscribers A and C for subscribers B and subscribers A and B for C.

Typically, however, modern cells are sectorized so that base stations operating in a common frequency band are often in a parallel orientation and facing in the same direction. As such, it is unlikely that if C is a co-channel interferer for A in cell α, that A will be a co-channel interferer for C in cell γ. Rather, it is more likely that C will have entirely different co-channel interferers.

In any event, those having ordinary skill in this art will readily recognize that the BSC will progressively gather not only considerable and well-correlated information about the frequency-hopping tendencies of its active subscribers, but significant DoA and/or ToA information as well.

Bearing in mind the number of subscribers and the speed at which frames arrive, within a relatively short period of time, the BSC will be in a position to predict, not only when and which co-channel interferers will appear, but also from what general direction, so that a null may be generated in that direction.

Moreover, because of the multiple responses regarding a particular subscriber, that is, in a given frame, both the base station corresponding to the cell in which the subscriber appears, and those potentially several base stations receiving the subscriber's signal as co-channel interference, will have forwarded a DoA and/or ToA estimate.

Those having ordinary skill in this art will appreciate that the DoA information does not always reflect a direct path between the transmitter and receiver (not shown). In a multi-path environment, the DoA metric may correspond to a reflection or diffraction. Nevertheless, the DoA is a slowly varying parameter that does not significantly impact null steering performance, whether it corresponds to a line of sight (LoS) path or a reflected/diffracted propagation path.

From this information, it may be possible to quite accurately determine the direction that the nulls generated by base station X should extend. For this purpose, the fact that a DoA metric represents a multi-path reflection or diffraction is not generally significant, so that the null steering approach should work, even taking into account multi-path reflections.

Furthermore, in the subsequent frame, conceivably, an almost entirely new set of base stations will provide a further set of well-correlated DoA and/or ToA estimates by which the position of the nulls for both frames can be accurately triangulated. Indeed, because the mobile subscriber is unlikely, in the very short time period between consecutive frames to have moved significantly in position within the network, the two (and even more) sets of DoA and/or ToA estimates could be effectively combined to great effect.

In addition to being able to provide null steering interference reduction in a frequency hopping technique, the information provided in the present invention will also provide the network operator with hitherto unrealizable capabilities. For example, it is relatively straightforward with the information maintained by the BSC, to track disconnected calls and new incoming calls.

Of potentially greater import, with the triangulated positional information derived from the information forwarded to the BSC by the various base stations, there now is the possibility of an accurate subscriber radio location mechanism having the scope and capability of a Global Positioning System (GPS) locator, but without the installation of additional hardware such as geosynchronous satellites, or the requirement for the subscriber to carry GPS transponders. Such a subscriber location capability could be easily implemented using existing network and handset technology and could provide positioning information, for example, for the E-911 (Enhanced 911) emergency services initiative to be shortly implemented by various governments.

However, in a multi-path environment, the capability of performing radio location may suffer from significant performance degradation when there is a high probability of receiving non-line of sight (NLOS) paths.

Even so, the BSC database built to predict the interferers for the adaptive null steering methodology may still be used to derive an innovative radio location methodology. This is because the DoA and ToA information garnered from the cell in which the subscriber is actually located will be bolstered by information from other cells, for which the subscriber acts as an interferer, in which the multi-path behaviour will be different. This information may be gleaned from the training sequence (TSC) or pilot information contained in the signal received at each base station, which is unique to a subscriber. It should therefore be possible to discount or compensate for the multi-path behavior and arrive at a true location for the subscriber in a robust manner.

Those having ordinary skill in this art will readily appreciate that other useful information may be discerned from the BSC databases, such as the power level of the desired and interfering signals, which could be of use to the null steering method.

Although, logically, the inventive method for adaptive null steering and radio location resides in the BSC because most of the information regarding the subscribers is already available, it is also possible to have a separate processor and/or equipment gathering the required information and implement the inventive method.

Because the foregoing embodiment assumes that each base station in the network is capable of generating DoA or ToA data with respect to its subscribers and any co-channel interferers, it operates in an environment in which each cell is serviced by a beamforming or so-called “smart” antenna system.

A second embodiment will now be described in which the present invention may be implemented, in the relatively frequent case where only a limited subset of cells in a network are serviced by a smart antenna system.

This may be the case, for example, where subscriber demand in a particular cell, without a smart antenna, outstrips available capability so that a smart antenna is introduced only into that cell. Usually, in such a case, the replaced conventional antenna will be redeployed in a new cell, which may not have, at least initially, the same subscriber demand as the first cell.

This scenario may also arise when a network operator is first evaluating a new smart antenna proposal. It is more likely that the evaluation would involve a solitary or a few cells in the network at first instance.

However the scenario arises, it is manifest that the first embodiment of the present invention would not be applicable, because only a small subset (perhaps only one) of cells would be serviced by a smart antenna system and thus have the capability to generate a DoA and/or ToA estimate.

Even if the network were fully populated with smart antenna systems, it is conceivable that such cells are not connected to a BSC. If so, again the first embodiment would not be applicable and manifestly, the ability to provide radio location would not be available.

Nevertheless, despite the absence of other smart antenna systems in the network, or even a BSC, for the particular cell of interest, which is serviced by a smart antenna system, it would be desirable to be able to provide null steering capability even in the presence of frequency hopping throughout the network.

The second embodiment of the present invention provides such capability while only imposing a nominal constraint on the network parameters. The nominal constraint is simply that for a cell being served by the smart antenna system and a small subset of other cells, the frequency hopping methodology is constrained to be cyclic rather than random.

Those having ordinary skill in this art will readily recognize that in a system comprising only cyclic frequency hopping systems, and in which all of the cells use the same number of transceivers, the interferers at any given frame would be entirely predictable, because all of the subscribers would hop from one frequency to another at the same time.

While clearly the assumption that each cell would have the same number of transceivers is not realistic, maintaining the cyclic, frequency hopping constraint permits the second embodiment of the present invention to perform null steering in the cell containing the smart antenna system without having to gather subscriber information in other cells.

Those having ordinary skill in this art will recognize that for a given network topology and frequency plan, the significant interferers to subscribers of the cell of interest will be statistically more likely to be located in a few of a limited subset of cells, which we denote dominant interfering cells.

Such cells should be easily identifiable using conventional measurements and network statistics as would be available to a network operator contemplating introducing a smart antenna into the cell of interest.

In these identified dominant interfering cells, the frequency hopping scheme is forced to be cyclic rather than random.

Because all other cells in the network are free to continue to use random (or, for that matter, cyclic) frequency hopping, the imposition of this slight constraint should not impose any significant performance degradation in terms of eliminating long-term fading of a signal.

Now, by way of example only, assume that the cell of interest is cell α and that subscriber A in that cell is free to hop between two frequencies f₁ and f₂. Assume further that there exists a dominant interferer B in cell β, which is free to hop between three frequencies f₁, f₃ and f₅. Those having ordinary skill in this art will readily recognize that in practice, the number of frequencies available in cyclic frequency hopping will be much greater.

If, in accordance with this second embodiment, both A and B are constrained to operate under cyclic frequency hopping, the two subscribers will collide, that is, share the same frequency, only once every six TDMA frames, namely when both A and B communicate along frequency f₁ (cf. Table 1). In the exemplary scenario shown in Table 1, this will take place commencing at frame 10, and every six frames thereafter, namely frames 16, 22, 28 etc.

In accordance with the present invention, base station α will record the DoA and ToA information received by it from A and B in these frames. However, in this second embodiment, rather than communicate this information to the BSC (which may not exist), it maintains its own database internally.

By the time base station α has reached frame 16, it recognizes that the periodicity of the collisions between A and B is six frames and it supplements its database to add this information as well. The periodicity will thereafter be confirmed in frame 22, 28 etc.

TABLE 1
Frequency of desired and interferer subscribers as a function of time

| Desired A | f₁ | f₂ | f₁ | f₂ | f₁ | f₂ | f₁ | f₂ | f₁ |
|---|---|---|---|---|---|---|---|---|---|
| Interferer B | f₁ | f₃ | f₅ | f₁ | f₃ | f₅ | f₁ | f₃ | f₅ |
| Frame # | 10 | 11 | 12 | 13 | 14 | 15 | 16 | 17 | 18 |

Thus, in this second embodiment, the re-occurrence of every dominant interferer will be defined by its time of occurrence (frame number) and periodicity (in frames) in the database maintained, which may be in the form shown in Table 2. However it is implemented, base station α will maintain such a database for each of its active subscribers:

TABLE 2
Database for the interferers' paths

| | Interferer 1 | . . . | Interferer N |
|---|---|---|---|
| Subscriber 1 | (FN_{1,1}⁰, Δ_{1,1}, p_{1,1}, FN_{1,1}) | | (FN_{1,N}⁰, Δ_{1,N}, p_{1,N}, FN_{1,N}) |
| . | | | |
| . | | | |
| . | | | |
| Subscriber L | (FN_{L,1}⁰, Δ_{L,1}, p_{L,1}, FN_{L,1}) | | (FN_{L,N}⁰, Δ_{L,N}, p_{L,N}, FN_{L,N}) |

As shown, the database of Table 2 has a capacity to maintain up to N columns, corresponding to different interferers for the subscriber. Rather than entering in the DoA as a parameter in the database, the angular space covered by the cell (or in modern sectorized networks, the sector) is divided into L sub-groups, each of which is assigned a few degrees. For example, in a tri-sector network, the angular space covered by the sector is 120°. Assuming that each of the L sub-groups is defined to cover a 4° portion thereof, the angular space of the sector would correspond to L=31 columns.

Thus, when the DoA is measured for an interferer, it is assigned to the closest one of the L DoA sub-groups and an entry inserted therein. Thus, provided that the DoA does not change by more than (in this case) 4° from frame to frame, the same entry in the database would be updated.

Those having ordinary skill in this art will recognize that the proper selection of the size of the angular sub-group will potentially impact the null-steering performance. With smaller angular sub-groups, it will be much more difficult to identify the correct periodicity of collisions between interferers and the subscriber of interest, as a new entry will be created every time the DoA falls within a different sub-group. Additionally, the use of slightly larger sub-groups will provide savings in memory and computational complexity. The upper limit for the size of the angular sub-group will be determined by the desired resolution for DoA information, sufficient for purposes of providing DoA information regarding interferers for purposes of null steering.

Each entry in the database reflects three or four parameters, namely the frame number of the initial collision FN_{i,j}⁰ between subscriber i and interferer j, the periodicity of collisions Δ_{i,j}, optionally, the path power of the interferer p_{i,j} and the frame number corresponding to the last collision FN_{i,j}.

The database will not be completed until there are a minimum number, for example, three collisions between a subscriber and an interferer. For example, where there are collisions between a subscriber i and an interferer j at frames 5, 9 and 13, an entry will be created for that subscriber and interferer listing FN_{i,j}⁰=5, Δ_{i,j}=4 and FN_{i,j}=13. If the path power metric is used, filtering should be considered especially in fading environments. However, it is expected that using a predetermined value in the adaptive beamformer will provide adequate results.

Including the frame number of the last collision permits the database to be pruned to remove entries that may no longer be valid. For example, if the last collision occurred a predetermined time (in frames) ago, this might reflect that the interferer is no longer radiating or that it has moved sufficiently, such as to another cell, that it no longer constitutes a dominant interferer. In such a case, it may be appropriate to delete the entry corresponding to this interferer.

This second embodiment can easily handle dynamic channel allocation and track mobile environments. The number of DoAs will be reduced, for example to 31 in the case of 120-degree sector coverage. The best performance is achieved when the DoA values are detected and used for a long time since they correspond to strong and persistent interfering sources.

The method could be equally applied to the uplink or downlink channels.

In an experimental implementation of this second embodiment, the frame number is mapped to an active entry in the DoA database simply by checking that the difference between frame numbers and the time of occurrence is an integer multiple of the periodicity. An active entry means that the periodicity is not zero. If no interferers correspond to the current frame number, the inactive entries are checked as possible candidates.

Those skilled in this art are familiar with methods of estimating the direction of arrival of the desired and interfering signals. The known pilot or training sequence may be used to distinguish the desired DoA from interfering signals' DoA.

If the estimated DoA does not exist in the database, then it is a new entry (FN_{k,1},Δ_{k,1},p_{k,1},FN_{k,1}) with Δ_{k,1}=0.

If (FNₖⁱ−FN)≡0[Δₖ] or (FNₖ₋₁ⁱ−FN)≡0[Δₖ₋₁] or (FNₖ₊₁ⁱ−FN)≡0[Δₖ₊₁] then the estimated DoA is classified to the corresponding entry. The 4^{th} argument of (FN_{k,1},Δ_{k,1},p_{k,1},FN_{k,1}), in case of (FNₖⁱ−FN)≡0[Δₖ], will be FN. Comparisons of previous and future DoA measurements constitutes environment tracking of a kind.

If more than 3 entries for the same DoA have Δ=0 then the differences between their frame numbers is compiled. If the differences have a common value Δ then one entry is kept and the other entries corresponding to the same DoA are deleted because the other two entries are now redundant information. The common value A is now known as the periodicity of that DoA.

To keep a reasonable size for the database, any DoA that was not detected again after a certain number of cycles (say 16 for example) could be removed from the database.

Since the frequency hopping scheme for the desired user is known, a single database is established for every active user. Before doing any operation on the database, the frame numbers are mapped to frequencies to ensure that one is dealing with the actual co-channel interferer. The simplest way to implement this mapping is to add a fifth parameter in the DoA entry that corresponds to the frequency channel number (0 to 63).

To compute beamforming weights for the frame number FN:

If (FNₖⁱ−FN)≡0[Δₖ] and (FNₖ−FN)≡0[Δₖ] then the corresponding entry is kept as a candidate.

If (FNₖⁱ−FN)≡0[Δₖ] and (FNₖ−FN)≠0[Δₖ] then the corresponding entry is kept as a back-up candidate. This is because the entry was not detected recently, so the environment may have started to change.

Next, the candidate entries are considered in turn. If no candidates were found, the back-up candidates are considered.

If the number of DoAs is greater than 2 then the strongest ones are considered first. This may be determined by comparing the powers. Because the powers could change dramatically between frequency hopping cycles, preferably some sort of filtering is performed.

The beamforming weights are a function of steering vectors, powers and a diagonal loading constant.

Nulls broadening may be applied to enhance the performance.

Downlink adaptive beamforming in a cyclic slow frequency hopping environment will rely on the DoA estimation of the desired and the interfering signals and their powers. All these parameters will be estimated from one DoA process. Since the DoA process depends on the training sequence, the processing may preferably be delayed for one frame.

At a particular frame number, all the potential candidates as interferers are found from the database and the one or two strongest interferers are identified. A potential candidate is identified if the difference between the current frame number and the recorded frame number in the database is a multiple of the periodicity.

In the single interferer case the weights are given by:

$$w = {a}_{d} - c \cdot {a}_{i} , \\ c = \frac{{a}_{i}^{H} {a}_{d}}{{a}_{i}^{H} {a}_{i} + \frac{{σ}^{2}}{{p}_{i}}} . \qquad ( 1 )$$

where:
aₓ is the steering vector for the desired, interferer subscriber, first interferer or second interferer respectively for x=d,i,1,2;
c is the correlation factor,
p is the power; and
σ² is a small constant that could be removed in the future to further simplify the process.

In the two interferers case, the weights are simply

$$\begin{matrix}w = {a}_{d} - {c}_{2 d} \cdot {a}_{2} - α \cdot {u}^{H} {a}_{d} \cdot u , \\ u = {a}_{1} - {c}_{21} {a}_{2} , & ( 2 ) \\ {c}_{21} = \frac{{a}_{2}^{H} {a}_{1}}{{a}_{2}^{H} \cdot {a}_{2} + \frac{{σ}^{2}}{{p}_{2}}} , & ( 3 ) \\ {c}_{2 d} = \frac{{a}_{2}^{H} {a}_{d}}{{a}_{2}^{H} \cdot {a}_{2} + \frac{{σ}^{2}}{{p}_{2}}} , & ( 4 ) \\ α = \frac{1}{{a}_{1}^{H} u + \frac{{σ}^{2}}{{p}_{1}}} & ( 5 )\end{matrix}$$

The present invention can be implemented in digital electronic circuitry, or in computer hardware, firmware, software, or in combination thereof. Apparatus of the invention can be implemented in a computer program product tangibly embodied in a machine-readable storage device for execution by a programmable processor; and actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; CD-ROM disks; and buffer circuits such as latches and/or flip flops. Any of the foregoing can be supplemented by, or incorporated in ASICs (application-specific integrated circuits), FPGAs (field-programmable gate arrays) or DSPs (digital signal processors).

Examples of such types of computers are contained in the base transceiver station and base station controller, suitable for implementing or performing the apparatus or methods of the invention. The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

The embodiments of the present invention for which an exclusive property or privilege is claimed are:

1. A method of adaptive null steering signals in a wireless frequency hopping network between a first base station and a subscriber in a first cell associated with the first base station, and a second base station and at least one interferer in a second cell associated with the second base station that periodically communicates along at least one common frequency simultaneously used in communications between the first base station and the subscriber and interferes therewith, comprising the steps of:
(a) measuring arrival information and a time received of a subscriber signal emanating from the subscriber and received by the first base station along a first subscriber frequency;
(b) measuring arrival information and a time received of an interferer signal emanating from the interferer along a first interferer frequency and received by the first base station;
(c) repeating all previous steps, for subsequent frequencies, until a periodicity of simultaneous communication by the interferer along the interferer signal and the subscriber along the subscriber signal can be established with the first base station along one of the at least one common frequency; and
(d) thereafter generating, at the first base station, a null in a most recent direction of the interferer signal, when the first base station and the subscriber communicate and the interferer interferes therewith along the at least one common frequency;
whereby interference by the interferer with communications between the first base station and the interferer along the at least one common frequency can be attenuated.

2. A method according to claim 1, wherein the first base station communicates all measurements thereof to a base station controller.

3. A method according to claim 2, further comprising a step before step (c) of measuring arrival information and a time received of the interferer signal emanating from the interferer along the at least one common frequency and received by the second base station and communicating all measurements thereof to the base station controller.

4. A method according to claim 2, further comprising a step before step (c) of measuring arrival information and a time received of the interferer signal emanating from the interferer along the first interferer frequency and received by a third base station and communicating all measurements thereof to the base station controller.

5. A method according to claim 2, wherein the step of generating a null comprises the base station controller communicating to the first base station a predicted time and direction of the interferer signal from the interferer to the first base station.

6. A method according claim 2, wherein the step of generating a null comprises the base station controller correlating all communicated measurements.

7. A method according claim 3, wherein the step of generating a null comprises the base station controller correlating all communicated measurements.

8. A method according claim 4, wherein the step of generating a null comprises the base station controller correlating all communicated measurements.

9. A method according to any one of claims 1 through 4, wherein the step of generating a null comprises compensating for multi-path effects from considering all communicated measurements.

10. A method according to any one of claims 1 through 4, wherein the step of measuring arrival information comprises measuring a direction of arrival.

11. A method according to any one of claims 1 through 4, wherein the step of measuring arrival information comprises measuring a time of arrival.

12. A method according to any one of claims 1 through 4, wherein the step of measuring arrival information comprises measuring a source of the signal received.

13. A method according to any one of claims 1 through 4, wherein the step of measuring arrival information comprises measuring a source of the signal from a training sequence contained therein.

14. A method according to any one of claims 1 through 4, wherein the step of measuring arrival information comprises measuring a source of the signal from a pilot tone associated therewith.

15. A method according to claim 2, wherein the base station controller identifies the location of the subscriber from the communicated measurements.

16. A method according to claim 2, wherein the base station controller identifies the location of the interferer from the communicated measurements.

17. A method according to claim 1, wherein the first and second base stations employ cyclic frequency hopping with all users associated therewith.

18. A method according to claim 7, wherein the step of generating a null comprises the first base station correlating all measurements.

19. A method according to claim 13, further including the step of locating a subscriber based on the training sequence contained in the interferer signals received at each base station.

20. A method according to claim 14, further including the step of locating a subscriber based on the pilot tone associated with the interferer signals received at each base station.

21. A system for adaptive null steering of signals in a wireless frequency hopping network comprising:
a first base station having a first cell;
a subscriber operatively associated to the first base station and operatively located in the first cell;
a second base station having a second cell; and
at least one interferer operatively associated to the second base station and operatively located in a second cell; and
wherein the interferer is adapted to periodically communicate along at least one common frequency simultaneously used in communications between the first base station and the subscriber,
wherein the first base station is adapted to measure the arrival information and a time received of a subscriber signal emanating from the subscriber and received by the first base station along a first subscriber frequency, and adapted to measure the arrival information and a time received of an interferer signal emanating from the interferer along the at least one common frequency and received by the first base station, and
wherein the first base station is adapted to repeat the measurements for subsequent subscriber and interferer frequencies, until a periodicity of simultaneous communication by the interferer and between the subscriber and the first base station along the at least one common frequency, can be established by the first base station, and
wherein the first base station is adapted to generate a null in a most recent direction of the interferer signal, when the first base station and the subscriber communicate and the interferer interferes therewith along the at least one common frequency, to attenuate the interference by the interferer signal.
